(19) United States
(12) Patent Application Publication
(10) Pub. No.: US 2017/0156314 A1
(43) Pub. Date: Jun. 8, 2017

(54) GIBBERELLIN FORMULATIONS

(71) Applicant: Valent BioSciences Corporation, Libertyville, IL (US)

(72) Inventor: Bala N. Devisetty, Buffalo Grove, IL (US)

(21) Appl. No.: 15/371,415

(22) Filed: Dec. 7, 2016

Related U.S. Application Data
(60) Provisional application No. 62/263,838, filed on Dec. 7, 2015.

(51) Int. Cl. A01N 25/02; A01N 25/30; A01N 43/12

(52) U.S. Cl. CPC A01N 25/02; A01N 43/12; A01N 25/30

(57) ABSTRACT

The invention relates to low volatile organic chemical gibberellin formulations and methods of their use.

### FIELD OF THE INVENTION

The present invention relates to gibberellic acid (“GA₃”), gibberellin₄ (“GA₄”), gibberellin₇ (“GA₇”), or gibberellin_{4/7} (“GA_{4/7}”) formulations containing low amounts of volatile organic chemicals (“VOCs”) and methods of their use.

### BACKGROUND OF THE INVENTION

Gibberellins are a class of plant growth regulators which are diterpenoid acids. Gibberellins are commercially produced by fermentation of a natural fungus, Gibber ellafugikuroi. Gibberellins are marketed under various trade names and are commercially used on a variety of fruit orchards, vegetable crops, row crops, and ornamental crops. The predominantly used gibberellin is GA₃.

VOCs contribute to the formation of ground-level ozone, which is harmful to human health and vegetation when present at high enough concentrations. Gibberellin formulations with greater than 25% emission potential, as determined by thermo gravimetric analysis (“TGA”), are considered High-VOC products by CADPR (California Department of Pesticide Regulation). TGA involves heating a pesticide sample in an environmentally controlled chamber while the rate of sample mass loss is measured. CADPR states that the emission potential of a pesticide formulation is determined by taking the mean of three replicate TGA measurements of the pesticide(s) and then subtracting the percent water and the exempt compounds from the measurement. The TGA process is well known by those of skill in the art.

Gibberellin solution formulations of the prior art are disadvantageous in several respects. The formulations are less concentrated due to low solubility of gibberellins, have limited storage stability, and/or contain unacceptable amounts of VOCs.

In order to overcome solubility issues, some formulations use solvents with amounts of VOCs that are not safe for the environment. For example, isopropyl alcohol and methyl alcohol offer severe disadvantages such as flammability and toxicity, which lead to restrictions in manufacturing, packaging, labeling, transportation, and warehousing of such solutions. Tetrahydrofurfuryl alcohol (“THFA”) is considered corrosive to the eye and skin.

Moreover, the low solubility of GA₃, GA₄, GA₇, and GA_{4/7} in some solvents, such as propylene glycol, does not permit preparation of high potency solution formulations. These low strength solution formulations require larger packaging, more storage space, and higher associated transportation, warehousing, and container disposal costs. Due to very low solubility and undesirable hydrolysis, it has been especially difficult to formulate GA₃in aqueous systems.

One way to overcome the solubility issues with GA₃, GA₄, GA₇, and GA_{4/7} is to prepare soluble powder formulations. These powder formulations dissolve readily when mixed with water and form true solutions. Once the solution is formed, no further mixing or agitation of the tank-mix is required.

Another way to overcome the solubility issues is to create a wettable powder. A wettable powder formulation is a dry, finely ground formulation. In this type of formulation, the active ingredient is combined with a finely ground dry carrier, usually a mineral clay, along with other ingredients that enhance the ability of the powder to be suspended in water. Upon mixing the wettable powder with water, a suspension is formed, which is then applied by a spray technique. Often the spray liquid must be continuously mixed to prevent settling of insoluble compositions.

However, wettable powders and soluble powder formulations tend to produce dust upon handling, such as when pouring, transferring or measuring them. This dust may pose health hazards. Further, powder formulations tend to wet poorly and also solubilize slowly upon addition to water. Powder formulations thus take longer times to wet, disperse and solubilize in the tank-mix. Formation of lumps or partially solubilized spray solutions will lead to uneven distribution of the plant growth regulator in the tank-mix with potential for reduced field performance. Sometimes, foam in the spray tank caused by spray tank adjuvants can also affect wetting and solubility of wettable and soluble powders. Wettable powder formulations will also leave undesirable insoluble residues both in the tank and on the sprayed foliage and fruit.

Another type of agricultural formulation is a tablet. Tablet formulations are pre-measured dosage delivery systems. They are useful in small areas, or for ornamental purposes. Tablet formulations may be effervescent, which dissolve in water over a period of two to ten minutes depending upon the type and size of the tablet. However, tablets generally deliver only between 0.1 to 1 gram of active ingredient per tablet. They are not ideal for large-scale field operations. Moreover, effervescent tablets are highly susceptible to humidity and may be slow to dissolve and are expensive.

Yet another type of agricultural formulation is a water-dispersible granule. Water-dispersible granules are also known as wettable granules or dry flowables. This type of formulation is similar to a wettable powder, except that the active ingredient is formulated as a dispersible granule. To prepare the water-dispersible granules for spray application, they are dispersed in water and form a suspension upon agitation. Many different water-dispersible granular formulations are known for agricultural chemicals. For example, EP 0 252 897 and U.S. Pat. No. 4,936,901 disclose encapsulated plant growth regulators in water dispersible granular formulations; and U.S. Pat. No. 5,622,658 discloses an extrudable composition for preparing water-dispersible granules.

Water-dispersible granules usually have no greater than eight percent moisture content, and form suspensions when added to aqueous solutions. The resulting suspension must be agitated for a period of time in order to fully disperse it. Agitation or by-pass recirculation of the tank-mix must also be maintained during application. The quality of water-dispersible granules is highly process- and active-ingredient-dependent; and can result in low yield recoveries, poor attrition resistance leading to dust potential, high manufacturing cost and poor dispersion. Generally, sprays of dissolved water-dispersible granular formulations leave undesirable insoluble residues on the treated foliage and fruit.

For GA₃, GA₄, GA₇, and GA_{4/7} formulations to be efficacious, the active ingredient must solubilize in tank-mixes prior to application. Otherwise, product efficacy will be severely affected. When water-dispersible granules are used, the grower often may not know when he has achieved the total solubility of the active ingredient in the spray solutions. In addition, water-dispersible granules can harden over time and thus result in poor dispersibility and solubility of the active ingredient. In addition, dust and caking may be problems with certain water-dispersible granules and powder formulations.

U.S. Pat. No. 6,984,609 discloses a concentrated, water-soluble, granular plant growth regulator formulation that is commercially available as ProGibb® 40% (available from Valent BioSciences Corp., ProGibb is a registered trademark of Valent BioSciences Corp.). The disclosed granules swiftly dissolve in water and provide a true solution without any insoluble particulates in the spray mixture. ProGibb® 40% is a reliable chemical thinner for grape vines. However, some growers would prefer solution formulations that are easier to apply.

Therefore, there is a need for environmentally safe, non-phytotoxic, efficacious, high strength gibberellin solution formulations. The improved formulations should overcome the toxicity, handling, storage, transportation, human exposure, and solubility issues encountered by prior art formulations. The formulations should also include low amounts of VOCs in order to be environmentally safe and be safer for growers to tank mix prior to application.

### SUMMARY OF THE INVENTION

The present invention is directed toward GA₃, GA₄, GA₇, and GA_{4/7} formulations that have low VOC levels.

In one aspect, the invention is directed to liquid agricultural formulations comprising from about 0.1 to about 29% wt/wt of at least one gibberellin selected from the group consisting of GA₃, GA₄, GA₇, and GA_{4/7} and from about 71 to about 99.9% wt/wt of at least one solvent selected from the group consisting of C8 to C12 fatty acid dimethylamides.

In another aspect, the invention is directed to methods for regulating plant growth comprising the step of treating a seed, soil or a plant with an effective amount of the formulations of the present invention.

### DETAILED DESCRIPTION OF THE INVENTION

Applicant has developed a concentrated gibberellin formulation by using a mixture of C8 to C10 fatty acid dimethylamides as a solvent (see Example 1 below). This formulation has low levels of VOCs and is environmentally safe.

In one embodiment, the present invention is directed to liquid agricultural formulations comprising from about 0.1 to about 29% wt/wt of at least one gibberellin selected from the group consisting of GA₃, GA₄, GA₇, and GA_{4/7} and from about 71 to about 99.9% wt/wt of at least one solvent selected from the group consisting of C8 to C12 fatty acid dimethylamides.

In a preferred embodiment, the solvent is a mixture of C8 to C10 fatty acid dimethylamides or a mixture of C10 to C12 fatty acid dimethylamides. In a more preferred embodiment, the solvent is a mixture of C8 to C10 fatty acid dimethylamides. A mixture of C8 to C10 fatty acid dimethylamides is commercially available as Agnique® AMD 810 (Agnique is available from BASF and a registered trademark of Cognis Corporation).

In a further embodiment, the formulation comprises a polyethylene glycol. Polyethylene glycol (“PEG”) is a polyether compound with the structure: H—(O—CH₂—CH₂)n—OH. PEGs are prepared by polymerization of ethylene oxide and are commercially available over a wide range of molecular weights. The number following “polyethylene glycol,” or “PEG,” refers to the molecular weight. For example, PEG 200 has a range of molecular weights from 190 to 210, PEG 300 from 285 to 315, and PEG 400 from 380 to 420 daltons.

In a preferred embodiment, the solvent is a mixture of C8 to C10 fatty acid dimethylamides and the formulation further comprises polyethylene glycols with average molecular weights of from about 190 to about 420 daltons. In a more preferred embodiment, the solvent is a mixture of C8 to C10 fatty acid dimethylamides and the formulation further comprises polyethylene glycols with average molecular weights of from about 190 to about 210 daltons.

The formulations of the present invention can also include a surfactant. Non-ionic or anionic surfactants can be used in formulations of the present invention. Surfactants that could be used include, but are not limited to, sorbitan derivatives such as Tween® 80Tween® 85(Tween® is a registered trademark of Croda Americas, Inc., Tween® 80 and 85 are available from Croda, Inc.), ethoxylated alcohols such as Brij® 98 (Brij® is a registered trademark of Uniqema Americas LLC, Brij® 98 is available from Croda Inc.), ethoxylated alkylphenols such as Igepol CA-630, Igepol, and Igepol CO-630 from Rhodia Inc., ethoxylated fatty acids such as Myrj® 52 (Myrj® is a registered trademark of Atlas Powder Company, Myrj® 52 is available from Croda Inc.), silicone based surfactants such as Silwet L-77® (Silwet and Silwet L-77 are registered trademarks of Momentive Performance Chemicals, Silwet L-77® is available from Momentive Performance Chemicals), and block polymeric surfactants such as Pluronic® P85 and Pluronic® P104 (Pluronic is a registered trademark of BASF Corporation, Pluronic® P85 and P104 are available from BASF Corporation). The percent surfactant in the formulation may range from 0.1 to 5% by weight depending upon the desired formulation characteristics and end use. Preferably, the surfactant is from about 0.1 to about 4, from about 0.1 to about 3, from about 0.1 to about 2, from about 0.1 to about 1, or from about 0.3 to about 0.5% by weight of the formulation.

Preferably, polysorbate surfactants are used in the formulations of the present invention. Polysorbate surfactants are produced by reacting the polyol sorbitol with ethylene dioxide. The number that follows “polysorbate” refers to the number of moles of ethylene dioxide that has been reacted per mole of sorbitol. The polyoxyethylenated sorbitan is then reacted with fatty acids obtained from vegetable fats and oils such as lauric acid, palmitic acid, stearic acid, and oleic acid. Examples of polysorbate surfactants include polysorbate 20, polysorbate 40, polysorbate 60, and polysorbate 80. One preferred polysorbate surfactant is polysorbate 20.

Polysorbate 20 is a nonionic surfactant that can be used in the formulations of the present invention as a surfactant. For example, Tween® 20 can be used to form the stable, environmentally safe formulations of the present invention. Tween® 20 is available from Croda, Inc.

In a preferred embodiment, the gibberellin is GA₃.

In another embodiment, the gibberellin is GA₄. In a further embodiment, the gibberellin is GA₇. In yet another embodiment, the gibberellin is GA_{4/7}.

In a preferred embodiment, the formulation comprises from about 1 to about 25% wt/wt of at least one gibberellin. In a more preferred embodiment, the formulation comprises from about 1 to about 20% wt/wt of at least one gibberellin. In a more preferred embodiment, the formulation comprises from about 10 to about 20% wt/wt of at least one gibberellin.

In another embodiment, the formulation comprises from about 75 to about 99% wt/wt of the at least one solvent. In a preferred embodiment, the formulation comprises from about 80 to about 99% wt/wt of the at least one solvent. In a more preferred embodiment, the formulation comprises from about 80 to about 90% wt/wt of the at least one solvent.

In another embodiment, the invention is directed to methods of regulating plant growth comprising the step of treating a seed, soil or a plant with an effective amount of the formulations of the present invention.

In a further embodiment, the formulations of the present invention are applied to plants or soil at a rate of from about 0.1 to about 50 grams of gibberellin per acre. In a preferred embodiment, the formulations are applied to the plants or soil at a rate of from about 1 to about 20 grams of gibberellin per acre. In a more preferred embodiment, the formulations are applied to the plants or soil at a rate of from about 1 to about 10 grams of gibberellin per acre.

The formulations of the present invention do not require isopropyl alcohol to dissolve the gibberellin. Isopropyl alcohol is considered a VOC by the US Environmental Protection Agency (“EPA”) and by the European Union (with a boiling point of 82.6° C.). As explained above, limitations of isopropyl alcohol formulations include flammability and toxicity, which lead to restrictions in manufacturing, packaging, labeling, transportation, and warehousing of such formulations. Isopropyl alcohol should be excluded from the formulations of the present invention in order to avoid these formulation limitations.

Formulations of the present invention may be used on any plant in need of gibberellin treatment, for example, on: artichokes to accelerate maturity and increase yield; blueberries to improve fruit set and fruit size; bananas to stimulate plant growth and reduce effects of stress, or post-harvest for maintaining fruit quality; carrots to maintain foliage growth during periods of stress; celery to increase plant height and yield; cherries to increase fruit size, firmness and quality or to delay maturity for a more orderly harvest; citrus to increase fruit set and yield, to delay rind aging, reduce physiological disorders, or delay maturity for a more orderly harvest; collard greens to facilitate harvest, increase yield, and improve quality; cotton to promote early season growth and increase seedling vigor; and cucumbers to stimulate fruit set during periods of cool weather; pasture land used for animal grazing; and corn. The formulations can be used post harvest on bananas and citrus, etc. Formulations of the present invention could also be used on grapes, melons, pecans, peppers, pineapples, rice, rhubarb, spinach, stone fruits, strawberries, rice, watercress and other plants in need of treatment.

Formulations of the present invention can also be used as a seed treatment or formulated as a sand granule.

The disclosed embodiments are simply exemplary embodiments of the inventive concepts disclosed herein and should not be considered as limiting, unless the claims expressly state otherwise.

The formulations of the present invention may be diluted with water and spray-applied. For example, when the plant is a fruit-producing plant, such as a grape plant, a grape-producing plant so treated produces larger grapes and/or grapes having higher percentage of soluble solids.

The term “effective amount” means the amount of the formulation that will provide the desired effect on the plant that is being treated. The “effective amount” will vary depending on the formulation concentration, the type of plants(s) being treated, and the result desired, among other factors. Thus, it is not always possible to specify an exact “effective amount.” However, an appropriate “effective amount” in any individual case may be determined by one of ordinary skill in the art. For example, effective amounts of formulations of the present invention may be from about 0.1 to about 50 grams of gibberellin per hectare.

Other plant growth regulators may be used in similar formulations to achieve stable and environmentally safe formulations. The phrase “plant growth regulator” as used herein connotes a product which serves to modify the growth and the development of a treated plant to agricultural maturity without killing the plant. Such modification may result from the effect of the material on the physiological processes of the plant, or from the effect of said material on the morphology of the plant. These modifications may also result from any combination or sequence of physiological or morphological factors.

Although gibberellin formulations are exemplified herein, the plant growth regulator may be used such as, a cytokinin such as TDZ, Kinetin, or 6-benzyladenine, an auxin, an organic acid, an ethylene biosynthesis inhibitor, or a combination thereof.

As mentioned above, formulations of the present invention have low levels of VOCs. Other diluents and surfactants may be in formulations of the present invention as long as the diluents and surfactants are “environmentally safe,” meaning that they are exempt from VOC regulation by the Environmental Protection Agency. The agricultural formulations of the present invention explicitly exclude organic solvents which are considered to have unsatisfactory VOC levels as defined by California Environmental Protection Agency. The agricultural formulations of the present invention explicitly exclude isopropyl alcohol. Further, the agricultural formulations of the present invention explicitly exclude ingredients which are considered by the state of California to cause cancer or reproductive toxicity under The Safe Drinking Water and Toxic Enforcement Act of 1986(see Health and Safety Code Section 25249.8(b)).

Other components of the formulation may be included in nominal amounts that do not affect the storage stability or low VOC characteristics of the present formulations. Additional components include surface active agents, crystal growth inhibitors, stickers, spreaders, leaf penetrants, dispersants, systemic acquired resistance inducers, systemic acquired resistance inhibiters, anti-foaming agents, preservatives, pH regulators, cosolvents, humectants, dyes, UV protectants, vehicles, sequestrants or other components which facilitate production, storage stability, product handling and application.

It is also contemplated that the ready-to-mix composition materials of this invention may be used in combination with other active ingredients, such as herbicides, fungicides, insecticides, bactericides, nematicides, biochemical pesticides, plant produced pesticides (botanicals), safeners or plant nutrients.

As used herein, the term “herbicide” broadly refers to compounds or compositions that are used as herbicides, as well as herbicide safeners and algicides. Herbicides may include, but are not limited to, 1,2,4-triazinones, 1,3,5-triazines, alkanamides (acetamides), anilides, aryloxyalkanoic acids, aryloxyphenoxypropionates, benzamides, benzamides (L), benzenedicarboxylic acids, benzofurans, benzoic acids (auxins), benzonitriles, benzothiadiazinones, benzothiazolones, carbamates (DHP), carbamates, chloroacetamides, cyclohexanedione oximes, dinitroanilines, dinitrophenols, diphenyl ethers, diphenyl ethers (cbi), glycine derivatives, halogenated alkanoic acids, hydroxybenzonitriles, imidazolinones, isoxazoles, isoxazolidinones, N-phenylphthalimides, organoarsenics, oxadiazoles, oxazolidinediones, oxyacetamides, phenoxycarboxylic acids, phenyl carbamate herbicides, phenylpyrazole herbicides, phenylpyridazines, phosphinic acids, phos-phorodithioates, phthalamates, pyrazole herbicides, pyridazines, pyridazinones (PDS), pyridazinones (PSII), pyridines, pyridinecarbox-amides, pyridinecarboxylic acids, pyrimidindiones, pyrimidines, pyrimidinyl-oxybenzoics, pyrimidinyloxybenzoic analogs, quinolinecarboxylic acids, BI class IV: thiocarbamate, semi-carbazones, sulfonylaminocarbonyl-triazolinones, sulfonylureas, tetrazolinones, thiadiazoles, thiocarbamates, triazoles, triazolinones, triazolopyrimidines, triketones, uracils, and ureas. Suitable herbicides include 2,3,6-TBA, 2,4,5-T, 2,4-D, 2,4-D-2-ethylhexyl, 2,4-DB, 2,4-D-dimethylammonium, 2,4-D-isopropyl, 2,4-D-isopropyl, 2,4-D-trolamine (2,4-D-triethanolamine), ACD 10614; ACD 10435, acetochlor, acifluorfen, acifluorfen-sodium, aclonifen, acrolein, AD 67, alachlor, alloxydim-sodium, ametryn, amicarbazone, amidosulfuron, amitrole, ammonium sulfamate, anilofos, asulam, atraton, atrazine, azafenidin, azimsulfuron, aziprotryne, barban, beflubutamid, benazolin, benazolin-ethyl, benfluralin, benfuresate, benoxacor, bensulfuron-methyl, bensulide, bentazone, benzobicyclon, benzofenap, benzoylprop, enzoylprop-ethyl, bifenox, bilanafos-sodium, bispyribac-sodium, borax, bromacil, bromobutide, bromofenoxim, bromoxynil, bromoxynil octanoate, bromoxynil-potassium, brompyrazon, butachlor, butafenacil, butenachlor, buthidazole, butralin, butroxydim, buturon, cafenstrole, calcium cyan-amide, carbetamide, carfentrazone-ethyl, chlomethoxyfen, chloramben, chlorbromuron, chlorbufam, chlorfenac, chlorfenac-sodium, chlorfenprop, chlorfenprop-methyl, chlorfenprop, chlorfenprop-ethyl, chlorflurenol-methyl, chloridazon, chlorimuron-ethyl, chlornitrofen, chloroacetic acid, chloro-toluron, chloroxuron, chlorpropham, chlorsulfuron, chlorthal-dimethyl, chlorthiamid, cinidon-ethyl, cinosulfuron, clodinafop-propargyl, clofop, clofop-isobutyl, clomazone, clomeprop, clopyralid, cloquintocet-mexyl, cl oransulam-methyl, credazine, cumyluron, cyanamide, cyanazine, cyclosulfamuron, cycloxydim, cycluron, cyhalofop-butyl, cyometrinil, daimuron, dazomet, desmedipham, desmetryn, di-allate, dicamba, dichlobenil, dichlormid, dichlorprop, dichlorprop soctyl, dichlorprop-P, diclofop, diclofop-methyl, diclosulam, diethatyl-ethyl; diethatyl, difenoxuron, difenzoquat metilsulfate, diflufenican, diflufenzopyr, dikegulac, dikegulac-sodium, dimefuron, dimepiperate, dimethachlor, dimethametryn, dimethipin, dimethylarsinic acid, dinitramine dinoseb, dinoseb acetate, dinoterb, diphenamid, dipropetryn, disul, disul-sodium, dithiopyr, diuron, DNOC, DSMA, eglinazine-ethyl, eglinazine, EL 177, endothal, ethalfluralin, ethametsulfuron-methyl, ethidimuron, ethofumesate, ethoxysulfuron, etobenzanid, fenchlorazole-ethyl, fenclorim, fenoprop, fenoprop-butotyl, fenoxaprop-ethyl, fenoxaprop, fenoxaprop-P, fenoxaprop-P-ethyl, fenthiaprop; fenthiaprop-ethyl, fentrazamide, fenuron, flamprop-methyl, flamprop-isopropyl, flamprop, flamprop-M-isopropyl, flamprop-M-methyl, flazasulfuron, florasulam, fluazifop-butyl, fluazifop-P, fluazifop-P-butyl, fluazolate, flucarbazone-sodium, fluchloralin, flufenacet, flumetsulam, flumiclorac-pentyl, flumioxazin, flumipropyn, fluometuron, fluorodifen, fluoroglycofen-ethyl, fluothiuron, flupoxam, flupropanate-sodium, flupyr-sulfuron-methyl-sodium, flurazole, flurenol-butyl, fluridone, flurochloridone, fluroxypyr, fluroxypyr-meptyl, flurtamone, fluthiacet-methyl, fomesafen, foramsulfuron, fosamine-ammonium, furilazole, glufosinate-ammonium, glyphosate, glyphosate-ammonium, glyphosate-i sopropylammonium, glyphosate-sodium, glyphosate-trimesium, halosulfuron-methyl, haloxyfop, haloxyfop-etotyl, haloxyfop-P, hexaflurate, hexazinone, imazamethabenz-methyl, imazamox, imazapic, imazapyr, imazapyr-isopropylammonium, imazaquin, imazethapyr, imazosulfuron, indanofan, iodosulfuron-methyl-sodium, ioxynil, ioxynil octanoate, ioxynil-sodium, isocarbamid, isocil, isomethiozin, isonoruron, isoproturon, isouron, isoxaben, isoxaflutole, isoxapyrifop, karbutilate, lactofen, lenacil, linuron, LS830556, maleic hydrazide, MCPA, MCPA-thioethyl, MCPB, MCPB-ethyl, mecoprop, mecoprop-P, medinoterb acetate, medinoterb, mefenacet, mefenpyr-diethyl, mefluidide, mesosulfuron-methyl, mesotrione, metamifop, metamitron, metazachlor, methabenzthiazuron, methazole, methiuron, methoprotryne, methoxyphenone, methyl isothiocyanate, methylarsonic acid, methyldymron, metobenzuron, metobromuron, metolachlor, metosulam, metoxuron, metribuzin, metsulfuron-, ethyl, MK-616, monalide, monolinuron, monuron, monuron-TCA, MSMA, naphthalic anhydride, naproanilide, napropamide, naptalam, NC-330, neburon, nicosulfuron, nitralin, nitrofen, nonanoic acid, norflurazon, oleic acid (fatty acids), orbencarb, oryzalin, oxabetrinil, oxadiargyl, oxadiazon, oxasulfuron, oxaziclomefone, oxyfluorfen, pendimethalin, penoxsulam, pentachloro-phenol, pentanochlor, pentoxazone, perfluidone, pethoxamid, phen-isopham, phenmedipham, phenylmercury acetate, picolinafen, primisulfuron-methyl, prodiamine, profluralin, proglinazine-ethyl, proglinazine, prometon, prometryn, propachlor, propanil, propaquizafop, propazine, propham, propisochlor, propoxycarbazone-sodium, propyzamide, prosulfuron, pyraflufen-ethyl, pyrazolynate, pyrazosulfuron-ethyl, pyrazoxyfen, pyribenzoxim, pyributicarb, pyridate, pyriftalid, pyriminobac-methyl, pyrithiobac-sodium, quinclorac, quinmerac, quinoclamine, quizalofop-ethyl, quizalofop-P-ethyl, quizalofop-P-tefuryl, rimsulfuron, sebuthylazine, secbumeton, siduron, simazine, simetryn, S-metolachlor, SMY 1500, sodium chlorate, sulcotrione, sulfentrazone, sulfometuron-methyl, sulfosulfuron, tebuthiuron, tepraloxydim, terbacil, terbumeton, terbuthylazine, terbutryn, thenylchlor, thiazafluron, thiazopyr, thidiazimin, thifensulfuron-methyl, thiobencarb, 1-dichloroacetylazepane, tralkoxydim, tri-allat, triasulfuron, tribenuron-methyl, trichloroacetic acid, triclopyr, tridiphane, trietazine, trifloxysulfuron-sodium, trifluralin, and triflusulfuron-methyl.

Fungicides may include, but are not limited to, amino acid amide carbamates, anilinopyrimidines, antibiotics, aromatic hydrocarbons, heteroaromatics, chloro/nitrophenyls, benzamides (F), benzenesulfonamides, benzimidazoles, benzimidazole precursors, benzotriazines, carboxamides, cinnamic acids, cyanoacetamide oximes, dicarboximides, dithiolanes, DMI: imidazoles, DMI: piperazines, DMI: pyrimidines, DMI: triazoles, enopyranuronic acid antibiotics, heteroaromatic hydroxyanilides, MBI: dehydratases, MBI: reductases, morpholine: morpholines, morpholine: spiroketalamines, multi-site: chloronitriles, multi-site: dimethyldithiocarbamates, multi-site: guanidines, multi-site: inorganics, multi-site: phthalimides, multi-site: quinones, multi-site: sulfamides, N-phenyl carbamate fungicides, organotin fungicides, phenylamide: acylalanines, phenylamide: butyrolactones, phenylamide: oxazolidinones, phenylpyrroles, phenylurea fungicides, phosphonates, phosphorothiolates, pyridazinone fungicides, pyrimidinamines, pyrimidinols, Qil, quinolines, SBI class IV: thiocarbamates, strobilurin analog: dihydrodioxazines, strobilurin type: imidazolinones, strobilurin type: methoxyacrylates, strobilurin type: ethoxycarbamates, strobilurin type: oxazolidinediones, strobilurin type: oximinoacetamides, strobilurin type: oximinoacetates, thiazolecarboxamides, thiocarbamate fungicides, and thiophenecarboxamides. Suitable fungicides include 1,2-dichloro-propane, 2-methoxyethylmercury chloride, 2-phenylphenol, 8-hydroxy-quinoline sulfate, ampropylfos, anilazine, azaconazole, azoxystrobin, benalaxyl, benodanil, benomyl, benquinox, benthiavalicarb-isopropyl, binapacryl, biphenyl, bis(tributyltin) oxide, bitertanol, blasticidin-S, borax, boscalid, bromuconazole, bupirimate, buthiobate, captafol, captan, carbendazim, carboxin, carpropamid, CGA 80 000, chinomethionat, chlobenthiazone, chloraniformethan, chloroneb, chlorothalonil, chlozolinate, climbazole, copper oxychloride, copper sulfate, copper sulfate (tribasic), cuprous oxide, cyazofamid, cyflufenamid, cymoxanil, cyproconazole, cyprodinil, cyprofuram, dazomet, dichlofluanid, dichlone, dichlorophen, diclobutrazol, diclocymet, diclomezine, dicloran, diethofencarb, difenoconazole, difenzoquat metilsulfate, diflumetorim, dimethirimol, dimethomorph, dimoxystrobin, diniconazole, dinobuton, dinocap, diphenylamine, ditalimfos, dithianon, dodemorph, dodemorph acetate, dodine, drazoxolon, edifenphos, epoxiconazole, etaconazole, etem, ethaboxam, ethirimol, etridiazole, famoxadone, fenamidone, fenarimol, fenbuconazole, fenfuram, fenhexamid, fenitropan, fenoxanil, fenpiclonil, fenpropimorph, fentin acetate, fentin hydroxide, ferimzone, fluazinam, fludioxonil, flumorph, fluoroimide, fluotrimazole, fluoxastrobin, fluquinconazole, flusilazole, flusulfamide, flutolanil, flutriafol, folpet, fosetyl-aluminum, fuberidazole, furalaxyl, furametpyr, furconazole-cis, furmecyclox, glyodin, griseofulvin, halacrinate, hexachlorobenzene, hexaconazole, hymexazol, imazalil, imibenconazole, iminoctadine triacetate, iminoctadine tris(albesilate), ipconazole, iprodione, iprovalicarb, isoprothiolane, kasugamycin hydrochloride hydrate, kresoxim-methyl, mebenil, mepanipyrim, mepronil, mercuric chloride, metalaxyl, metalaxyl-M, metconazole, methasulfocarb, methfuroxam, methyl iodide, methyl isothiocyanate, metominostrobin, metsulfovax, mildiomycin, myclobutanil, myclozolin, natamycin, nitrothal-isopropyl, nuarimol, ofurace, fatty acids), oxabetrinil, oxadixyl, oxpoconazole fumarate, oxycarboxin, penconazole, pencycuron, pentachlorophenol, phenylmercury acetate, phenylmercury dimethyldithiocarbamate, phenylmercury nitrate, phosphonic acid, phthalide, picoxystrobin, polyoxin B, polyoxorim, potassium bicarbonate, potassium hydroxyquinoline sulfate, prochloraz, procymidone, propamocarb hydrochloride, propiconazole, proquinazid, prothiocarb; prothiocarb hydrochloride, prothioconazole, pyracarbolid, pyraclostrobin, pyrazophos, pyributicarb, pyrimethanil, pyroquilon, quinoclamine, quinoxyfen, quintozene, silthiofam, simeconazole, sodium bicarbonate, spiroxamine, SSF-109, sulfur, tebuconazole, tecnazene, tetraconazole, thiabendazole, thicyofen, thifluzamide, thiophanate, thiophanate-methyl, thiram, tiadinil, tolclofos-methyl, tolylfluanid, triadimefon, triadimenol, triamiphos, triazoxide, trichlamide, tricyclazole, trifloxystrobin, triflumizole, triforine, triticonazole, urbacid, validamycin, vinclozolin, zarilamid, ziram, and zoxamide.

Bactericides may include, but are not limited to, bronopol, dichlorophen, nitrapyrin, nickel dimethyldithiocarbamate, kasugamycin, octhilinone, furancarboxylic acid, oxytetracyclin, probenazole, streptomycin, tecloftalam, copper sulfate and other copper preparations.

Insecticides, acaricides and nematicides may include, but are not limited to, abamectin, ABG-9008, acephate, acequinocyl, acetamiprid, acetoprole, acrinathrin, AKD-1022, AKD-3059, AKD-3088, alanycarb, aldicarb, aldoxycarb, allethrin, alpha-cypermethrin (alphamethrin), amidoflumet, aminocarb, amitraz, avermectin, AZ-60541, azadirachtin, azamethiphos, azinphos-methyl, azinphos-ethyl, azocyclotin, Bacillus firmus, Bacillus popilliae, Bacillus sphaericus, Bacillus subtilis, Bacillus thuringiensis, Bacillus thuringiensis strain EG-2348, Bacillus thuringiensis strain GC-91, Bacillus thuringiensis strain NCTC-11821, Bacillus thuringiensis israelensis, baculoviruses, Beauveria bassiana, Beauveria tenella, benclothiaz, bendiocarb, benfuracarb, bensultap, benzoximate, beta-cyfluthrin, beta-cypermethrin, bifenazate, bifenthrin, binapacryl, bioallethrin, bioallethrin-5-cyclopentyl isomer, bioethanomethrin, biopermethrin, bioresmethrin, bistrifluoron, BPMC, brofenprox, bromophos-ethyl, bromopropylate, bromfenvinfos (-methyl), BTG-504, BTG-505, bufencarb, buprofezin, butathiofos, butocarboxim, butoxycarboxim, butylpyridaben, cadusafos, camphechlor, carbaryl, carbofuran, carbophenothion, carbosulfan, cartap, CGA-50439, chinomethionat, chlorantraniliprole, chlordane, chlordimeform, chloethocarb, chlorethoxyfos, chlorfenapyr, chlorfenvinphos, chlorfluazuron, chlormephos, chlorobenzilate, chloropicrin, chlorproxyfen, chlorpyrifos-methyl, chlorpyrifos (-ethyl), chlovaporthrin, chromafenozide, cis-cypermethrin, cisresmethrin, cis-permethrin, clocythrin, cloethocarb, clofentezine, clothianidin, clothiazoben, codlemone, coumaphos, cyanofenphos, cyanophos, cyantraniliprole, cycloprene, cycloprothrin, cyfluthrin, cyflumetofen, cyhalothrin, cyhexatin, cypermethrin, cyphenothrin (1R-trans-isomer), cyromazine, DDT, deltamethrin, demeton-5-methyl, demeton-5-methylsulfone, diafenthiuron, dialifos, diazinon, dichlofenthion, dichlorvos, dicofol, dicrotophos, dicyclanil, diflubenzuron, dimefluthrin, dimethoate, dimethylvinphos, dinobuton, dinocap, dinotefuran, diofenolan, di sulfoton, docusat-sodium, dofenapyn, DOWCO-439, eflusilanate, emamectin, emamectin-benzoate, empenthrin (1R-isomer), endosulfan, Entomopthora spp., EPN, esfenvalerate, ethiofencarb, ethion, ethiprole, ethoprophos, etofenprox, etoxazole, etrimfos, famphur, fenamiphos, fenazaquin, fenbutatin oxide, fenfluthrin, fenitrothion, fenobucarb, fenothiocarb, fenoxacrim, fenoxycarb, fenpropathrin, fenpyrad, fenpyrithrin, fenpyroximate, fensulfothion, fenthion, fentrifanil, fenvalerate, fipronil, flonicamid, fluacrypyrim, fluazuron, flubendiamide, flubenzimine, flubrocythrinate, flucycloxuron, flucythrinate, flufenerim, flufenoxuron, flufenprox, flumethrin, flupyrazofos, flutenzin (flufenzine), fluvalinate, fonofos, formetanate, formothion, fosmethilan, fosthiazate, fubfenprox (fluproxyfen), furathiocarb, gamma-cyhalothrin, gamma-HCH, gossyplure, grandlure, granulosis viruses, halfenprox, halofenozide, HCH, HCN-801, heptenophos, hexaflumuron, hexythiazox, hydramethylnone, hydroprene, IKA-2002, imidacloprid, imiprothrin, indoxacarb, iodofenphos, iprobenfos, isazofos, isofenphos, isoprocarb, isoxathion, ivermectin, japonilure, kadethrin, nuclear polyhedrosis viruses, kinoprene, lambda-cyhalothrin, lindane, lufenuron, malathion, mecarbam, mesulfenfos, metaldehyde, metam-sodium, methacrifos, methamidophos, Metharhizium anisopliae, Metharhizium flavoviride, methidathion, methiocarb, methomyl, methoprene, methoxychlor, methoxyfenozide, metofluthrin, metolcarb, metoxadiazone, mevinphos, milbemectin, milbemycin, MKI-245, MON-45700, monocrotophos, moxidectin, MTI-800, naled, NC-104, NC-170, NC-184, NC-194, NC-196, niclosamide, nicotine, nitenpyram, nithiazine, NNI-0001, NNI-0101, NNI-0250, NNI-9768, novaluron, noviflumuron, OK-5101, OK-5201, OK-9601, OK-9602, OK-9701, OK-9802, omethoate, oxamyl, oxydemeton-methyl, Paecilomyces fumosoroseus, parathion-methyl, parathion (-ethyl), permethrin (cis-, trans-), petroleum, PH-6045, phenothrin (1R-trans isomer), phenthoate, phorate, phosalone, phosmet, phosphamidon, phosphocarb, phoxim, piperonyl butoxide, pirimicarb, pirimiphos-methyl, pirimiphos-ethyl, potassium oleate, prallethrin, profenofos, profluthrin, promecarb, propaphos, propargite, propetamphos, propoxur, prothiofos, prothoate, protrifenbute, pymetrozine, pyraclofos, pyrafluprole, pyresmethrin, pyrethrum, pyridaben, pyridalyl, pyridaphenthion, pyridathion, pyrimidifen, pyriprole, pyriproxyfen, quinalphos, resmethrin, RH-5849, ribavirin, RU-12457, RU-15525, rynaxapyr, S-421, S-1833, salithion, sebufos, SI-0009, silafluofen, spinosad, spirodiclofen, spiromesifen, sulfluramid, sulfotep, sulprofos, SZI-121, tau-fluvalinate, tebufenozide, tebufenpyrad, tebupirimfos, teflubenzuron, tefluthrin, temephos, temivinphos, terbam, terbufos, tetrachlorvinphos, tetradifon, tetramethrin, tetramethrin (1R-isomer), tetrasul, theta-cypermethrin, thiacloprid, thiamethoxam, thiapronil, thiatriphos, thiocyclam hydrogenoxalate, thiodicarb, thiofanox, thiometon, thiosultap-sodium, thuringiensin, tolfenpyrad, tralocythrin, tralomethrin, transfluthrin, triarathene, triazamate, triazophos, triazuron, trichlophenidine, trichlorfon, triflumuron, trimethacarb, vamidothion, vaniliprole, verbutin, Verticillium lecanii, WL-108477, WL-40027, y1-5201, y1-5301, y1-5302, XMC, xylylcarb, ZA-3274, zeta-cypermethrin, zolaprofos, ZXI-8901, the compound 3-methylphenyl propylcarbamate (Tsumacide Z), the compound 3-(5-chloro-3-pyridinyl)-8-(2,2,2-trifluoroethyl)-8-azabicyclo[3-.2.1]octane-3-carbonitrile (CAS-Reg. No. 185982-80-3) and the corresponding 3-endo-isomer (CAS-Reg. No. 185984-60-5) (cf. WO-96/37494, WO-98/25923), and also preparations which comprise insecticidally active plant extracts, nematodes, fungi or viruses.

As used herein, all numerical values relating to amounts, weight percentages and the like are defined as “about” or “approximately” each particular value, namely, plus or minus 10% (±10%). For example, the phrase “at least 5% by weight” is to be understood as “at least 4.5% to 5.5% by weight.” Therefore, amounts within 10% of the claimed values are encompassed by the scope of the claims.

The percentages of the components in the formulations are listed by weight percentage.

The following examples are intended to illustrate the present invention and to teach one of ordinary skill in the art how to make the formulations of the invention. They are not intended to be limiting in any way.

### EXAMPLES

Before preparing the formulations, the amount of the components must be calculated (see tables below). Applicants used GA₃ in the form of Technical Grade Active Ingredient (“TGAI”) when preparing formulations of the present invention. The percent GA₃ in the technical grade was 96.6% wt/wt. Variations in the activity of GA₃ in the TGAI should be accounted for by decreasing or increasing the amount of diluent in producing the desired percent of GA₃ formulation. This is standard practice within the guidelines of the US Environmental Protection Agency per 40 C.F.R. §158.175(b)(2).

### Example 1

### Preparation of a Low VOC Concentrated Gibberellic Acid Formulation

TABLE 1

| Material | % wt/wt | g/batch |
|---|---|---|
| GA₃ TGAI | 20.7 | 20.7 |
| C8 to C10 fatty | 79.3 | 79.3 |
| acid dimethyl | | |
| amides | | |
| Total | 100 | 100 |

The solvent was placed into a beaker with a stir bar. The GA₃ TGAI was then added and mixed for 30 minutes. A clear solution was obtained.

### Comparative Example 2

TABLE 2

| Material | % wt/wt | g/batch |
|---|---|---|
| GA₃ TGAI | 32.0 | 32.0 |
| C8 to C10 fatty | 67.0 | 67.0 |
| acid dimethyl | | |
| amides | | |
| Polysorbate 20 | 1.0 | 1.0 |
| Total | 100 | 100 |

The solvent and surfactant were placed into a beaker with a stir bar at 35 degrees Celsius. The GA₃ TGAI was then slowly added and mixed for 35 minutes. A clear solution was not obtained.

As illustrated by these examples, using a mixture of C8 to C10 fatty acid dimethylamides as a solvent overcomes the solubility issues of gibberellins at concentrations greater than 20% but less than 30%.

We claim:

1. A liquid agricultural formulation comprising from about 0.1 to about 29% wt/wt of at least one gibberellin selected from the group consisting of gibberellic acid (GA₃), gibberellin₄ (GA₄), gibberellin₇ (GA₇), and gibberellin_{4/7} (GA_{4/7}) and from about 71 to about 99.9% wt/wt of at least one solvent selected from the group consisting of C8 to C12 fatty acid dimethylamides.

2. The formulation of claim 1 wherein the at least one solvent is a mixture of C8 to C10 fatty acid dimethylamides.

3. The formulation of claim 2 wherein the formulation also comprises a polyethylene glycol.

4. The formulation of claim 3 wherein the polyethylene glycol have molecular weights from about 190 to about 210 daltons.

5. The formulation of claim 1 further comprising a surfactant.

6. The formulation of claim 5 wherein the surfactant is a polysorbate with 20 moles of ethylene oxide per mole of sorbitol.

7. The formulation of claim 1 wherein the gibberellin is GA₃.

8. The formulation of claim 1 wherein the gibberellin is GA₄.

9. The formulation of claim 1 wherein the gibberellin is GA₇.

10. The formulation of claim 1 wherein the gibberellin is GA_{4/7}.

11. The formulation of claim 1 comprising from about 1 to about 25 wt/wt of the at least one gibberellin.

12. The formulation of claim 1 comprising from about 1 to about 20% wt/wt of the at least one gibberellin.

13. The formulation of claim 1 comprising from about 10 to about 20% wt/wt of the at least one gibberellin.

14. The formulation of claim 1 comprising from about 75 to about 99% wt/wt of the at least one solvent.

15. The formulation of claim 1 comprising from about 80 to about 99% wt/wt of the at least one solvent.

16. The formulation of claim 1 comprising from about 80 to about 90% wt/wt of the at least one solvent.

17. A method of regulating plant growth comprising the step of treating a seed, soil or a plant with an effective amount of the formulation of claim 1.
